(19) United States
(12) Patent Application Publication
(10) Pub. No.: US 2019/0112968 A1
(43) Pub. Date: Apr. 18, 2019

(54) DIESEL ENGINE HAVING REENTRANT COMBUSTION CHAMBER

(71) Applicants: HYUNDAI MOTOR COMPANY, Seoul (KR); Kia Motors Corporation, Seoul (KR); AVL List GmbH, Graz (AT)

(72) Inventors: Chang-Yeol CHOI, Suwon-si (KR); Jun YU, Suwon-si (KR); Haeng-Pyo HEO, Hwaseong-si (KR); Thelliez Marina, Graz (AT); Tokaji Balazs, Budapest (HU); Egert Michael DI, Kainach (AT)

(21) Appl. No.: 16/128,420

(22) Filed: Sep. 11, 2018

(30) Foreign Application Priority Data
Oct. 17, 2017 (KR) 10-2017-0134550

(51) Int. Cl. F02B 23/06; F02F 3/28

(52) U.S. Cl. CPC F02B 23/0678; F02B 23/0648; F02B 3/08; F02F 3/28; F02B 23/0624

(57) ABSTRACT

A reentrant combustion chamber is disclosed. The reentrant combustion chamber includes a profile forming the inlet of the combustion chamber that is a projective surface formed inward in the combustion chamber and the bottom of the combustion chamber that is a recessed space that is recessed outward under the inlet in the combustion chamber, a cone formed in a truncated cone shape continuing from the profile and protruding to the central space in the combustion chamber, and a top end for expanding the space of the combustion chamber by expanding the top of the combustion chamber at the inlet of the combustion chamber.

### CROSS-REFERENCE TO RELATED APPLICATIONS

This application claims priority to Korean Patent Application No. 10-2017-0134550, filed on Oct. 17, 2017, which is incorporated herein by reference in its entirety.

### BACKGROUND

### Field

The present disclosure relates to a combustion chamber and, more particularly, a diesel engine having a reentrant combustion chamber suitable for a super-high pressure injection environment.

### Description of Related Art

In general, a diesel engine injects fuel to high-temperature and high-pressure compressed air, and ignites and burns the gas mixture, in which it is an important factor in combustion to generate streams of intake air and sprayed fuel and atomize injected fuel,

The streams are generated to mix well air and fuel by generating swirls, vortexes, or tumbles in a combustion chamber and the atomization is for making the injected fuel into many small droplets to promote mix of the sprayed fuel and the air of the atmospheric environment by increasing surface areas.

Accordingly, the combustion chamber of a diesel engine needs to have a shape (or structure) suitable for generating streams and atomizing fuel. For example, there are a spray divided type combustion chamber and a 2-step bowl type combustion chamber.

The spray divided type combustion chamber promotes stream generation and fuel atomization by generating small vortexes therein by spraying fuel to the upper wall thereof so divide the fuel up and down.

The 2-step bowl type combustion chamber has a large space defined by a bottom without a step and an upper wall with a step and promotes stream generation and fuel atomization by generating larger vortexes larger than small vortexes therein.

The disclosure of this section is to provide background of the invention. Applicant notes that this section may contain information available before this application. However, by providing this section, Applicant does not admit that any information contained in this section constitutes prior art.

### SUMMARY

To reduce smoke, it is desirable for the diesel engine to have an optimal shape that can generate strong vortexes in a combustion chamber and more effectively use fresh air with the entire air for combustion.

Further, when the fuel injection pressure of diesel engines has been increased over 2200 bar, having a combustion chamber shape suitable for such super-high injection pressure is desired.

In consideration of this problem, an aspect of the present invention is to provide a diesel engine having a reentrant combustion chamber suitable for a super-high injection pressure that has not been achieved from the spray divided type combustion chamber and the 2-step bowl type combustion chamber by changing the shape of an inlet of a combustion chamber and the shapes of the bottom of the combustion chamber continuing from the inlet and a cone continuing from the bottom of the combustion chamber to the center to be suitable for generating large vortexes, and particularly by associating the curve of the bottom increased by the reentrant shape of the inlet of the combustion chamber with the straight shape of the cone.

A reentrant combustion chamber according to a contain embodiment of the present invention includes: a profile forming the inlet of the combustion chamber that is a projective surface formed inward in the combustion chamber and the bottom of the combustion chamber that is a recessed space that is recessed outward under the inlet in the combustion chamber; a cone formed in a truncated cone shape continuing from the profile and protruding to the central space in the combustion chamber ; and a top end for expanding the space of the combustion chamber by expanding the top of the combustion chamber at the inlet of the combustion chamber.

The top end is formed by cutting the top of the profile at a combustion chamber expansion depth to expand the combustion chamber; the profile is divided into a slope that is an inclined surface continuing from the top end to the projective surface, a protrusion that is a projective surface continuing to the slope to form the inlet of the combustion chamber, and a bowl rim that forms the bottom of the combustion chamber that is the recessed space; and the cone is the truncated cone shape having a straight pip.

The slope continues to the protrusion through a slope curve formed from the top end. The protrusion continues to the bowl rim through a protrusion curve formed from the top end. The bowl rim curve is divided into a bottom curve continuing to the protrusion and a cone curve continuing to the cone. The truncated cone of the cone forms a straight oblique side.

The radius center of the recessed space is set as a combustion chamber reference diameter, and when the combustion chamber reference diameter is 100%, the minimum combustion chamber diameter defined by the protrusion is 120˜135%, the maximum combustion chamber diameter defined by the bowl rim is 120˜140%, and the pip diameter is 10˜15%.

When the height of the combustion chamber from the bottom to the top of the combustion chamber is 100%, the combustion chamber expansion depth is 4˜12% and the pip depth is 25˜42%.

A diesel engine according to a contain embodiment of the present invention includes: a piston having a reentrant combustion chamber defined by: a profile that forms the inlet of the combustion chamber protruding inward in the combustion chamber and the bottom of the combustion chamber through a recessed space that is recessed outward in the combustion chamber; cone that is formed in a truncated cone shape protruding with a straight oblique side at the central space in the combustion chamber; and a top end that expands the space of the combustion chamber and is formed by extending the top of the profile.

The reentrant combustion chamber has a left-right symmetric structure with a pip at the center. The combustion chamber is formed by connecting a slope curve and a protrusion curve having different sizes and the recessed space is formed by a bowl curve and the bowl curve is formed by connecting a bottom curve and a cone curve that have different sizes. The cone is a truncated cone and forms a tip at the center in the combustion chamber,

According to the combustion chamber of a certain embodiment , a large vortex in the combustion chamber is generated by using energy of prayed fuel by increasing the radius of the bottom using a reentrant type, and the smoothly stream flowing to the center of the combustion chamber is formed by a stream of sprayed fuel generated by the straight section.

Further, according to the diesel engine of a certain embodiment, since a large vortex and a stream flowing to the center of the combustion chamber is formed by the reentrant shape, the reentrant combustion chamber is suitable for super-high injection that cannot be achieved from the spray divided type combustion chamber and the 2-step bowl type combustion chamber. In particular, the combustion chamber is applied to the super-high injection of 2200 bar or more, so it can satisfy enhanced EM and regulations on fuel efficiency.

### BRIEF DESCRIPTION OF THE DRAWINGS

FIG. 1 is a view showing a diesel engine having a reentrant combustion chamber on the top of a piston according to embodiments of the present invention.

FIG. 2 is a view showing layouts of portions of the reentrant combustion chamber according to embodiments of the present invention.

FIG. 3 is a view showing a state in which fuel is sprayed into a reentrant combustion chamber of a diesel engine according to embodiments of the present invention,

FIG. 4 is an analysis diagram showing streams traveling to the center in the reentrant combustion chamber according to embodiments of the present invention when fuel is sprayed and burned, using a 3D velocity field.

FIG. 5 is a view showing the state in which a large vortex is generated to reduce smoke in the reentrant combustion chamber according to embodiments of the present invention.

FIG. 6 is a 3D analysis diagram showing a combustion result in the reentrant combustion chamber according to embodiments of the present invention.

### DETAILED DESCRIPTION

Hereinafter, embodiments of the present invention will be described in detail with reference to the accompanying drawing and the present invention may be achieved in various ways by those skilled in the art, so the present invention is not limited to the embodiments.

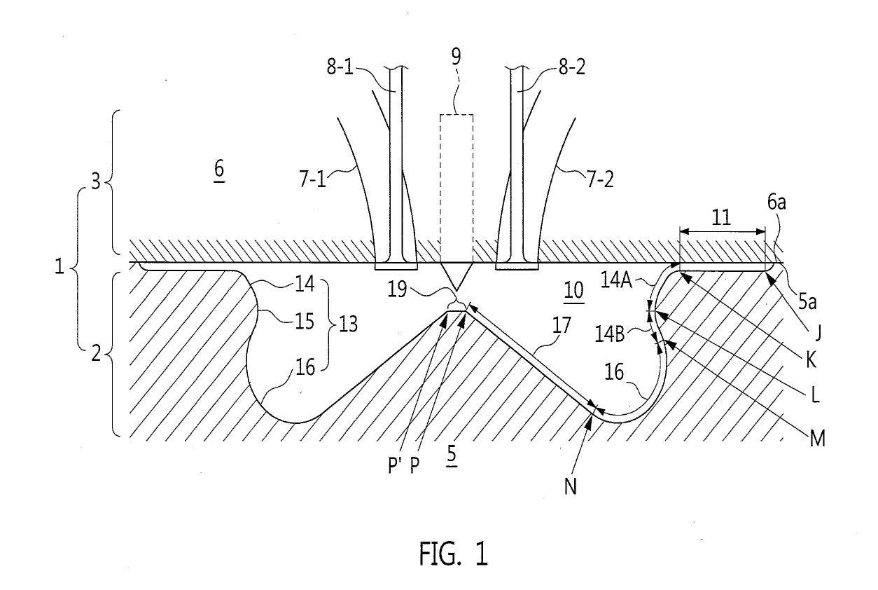

Referring to FIG. 1 showing the TDC (Top Dead Center) of a piston 5 in a diesel engine, in which the piston 5 has a reentrant combustion chamber 10, so large vortexes for fuel atomization and streams traveling to the center in the combustion chamber are smoothly generated by the reentrant shape.

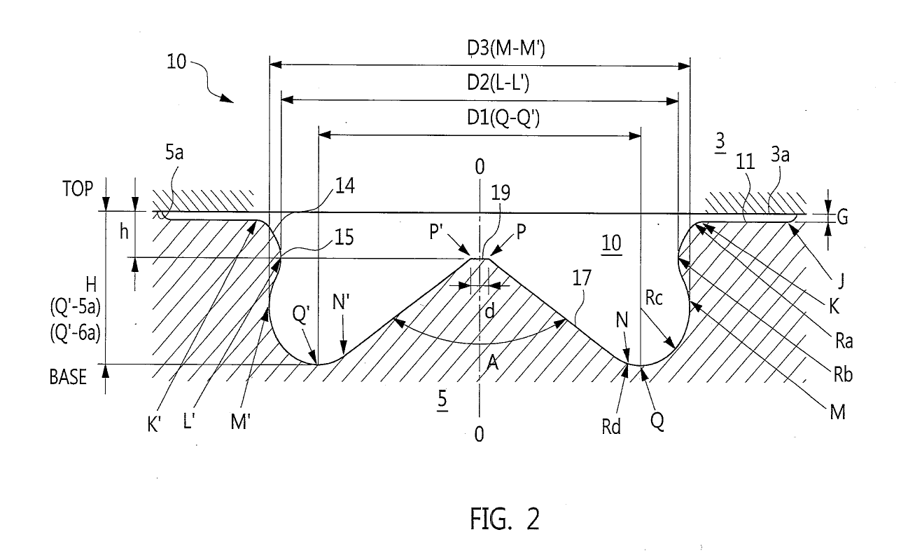

Referring to FIG. 1 and FIG. 2, in a cross section taken along a central axis (0-0 in FIG. 2), piston 5 and cylinder head 6 are symmetrical about the central axis (axis of piston movement), The piston comprises a first flat surface 11 (J to K), a second curved surface 14A (K to L), a third curved surface 14B (L to M), a fourth curved surface 16 (M to N), a fifth flat surface 17, and s sixth flat surface 19 connected in series. In embodiments, the second curved surface 14A, the third curved surface 14B, and the fourth curved surface 16 has different have different radii of curvature. The points K, L, M are points of inflection separating the second curved surface 14A, the third curved surface 14B, and the fourth curved surface 16. In embodiments, each of the curved surfaces 14A, 14B, 16 has two or more radii of curvature therein.

In embodiments, radius of curvature Ra at a point of the second curved surface 14A is smaller than radius of curvature Rb at a point L, radius of curvature Rb is smaller than radius of curvature Rc at a point of fourth curved surface 16, and radius of curvature Rc is smaller than radius of curvature Rd at point Q (end of the fourth curved surface 16). In embodiments, radius of curvature of the curved surfaces 14A, 14B, 16 gets greater gradually from point K to point N such that vortexes are growing along the curved surfaces (Fig.4 and Fig, 5). In embodiments, the curved surfaces 14A, 14B, 16 form a continuous surface having no point of discontinuity (no step from point K to point N).

In detail, the diesel engine 1 is divided into an engine body 2 and an upper body 3 and has the combustion chamber 10 between the engine body 2 and the upper body 3.

For example, the piston 5 having a reentrant combustion chamber 10 recessed on a piston top 5a coming in contact with a head bottom 6a of the upper part 3 is disposed in the engine body 2, which is the same as a common cylinder block. Accordingly, the engine body has an oil pan and a crankshaft configured with a cylinder block, and the cylinder block is connected to the piton 5 and outputs reciprocation of the piston 5 as engine torque.

For example, the upper part 3 has a cylinder head 6 having the head bottom 6a coming in contact with the top 5a of the cylinder 5, and the cylinder head 6 has an intake valve 8-1 for opening/closing an intake port 7-1 for supplying air to the reentrant combustion chamber 10, an exhaust valve 8-2 for opening/closing an exhaust valve 7-2 for discharging exhaust gas from the reentrant combustion chamber 10, and an injector 9 for spraying fuel to be burned with high-pressure compressed air into the reentrant combustion chamber 10 in a liquid state. Accordingly, the upper part 3 has the cylinder head 6, a cylinder head cover, and a camshaft, and the camp shaft control valve timing of the intake and exhaust valves 8-1 and 8-2.

For example, the reentrant combustion chamber 10 has an internal spaced divided into a top end surface 11, a profile 13, a cone 17, and a pip 19. The top end 11 is stepped on the piston top 5a to form the top of the reentrant combustion chamber 10, the pip 19 protrudes up at the center in the reentrant combustion chamber 10 at the tip of the cone 17 continuing to the bottom of the reentrant combustion chamber 10, the profile 13 has a bowl rim 16, a protrusions 15, and a slope 14 that continue from the bottom of the cone 17 to the top of the top end 11, whereby a lower inner wall is defined by the bowl rim 16 and an upper inner wall is defined by the protrusion 15 and the slope 14. Accordingly, the wall of the reentrant combustion chamber 10 is composed of the lower inner wall and the upper inner wall.

Accordingly, the combustion chamber 10 is a left-right symmetric cross-section with the pip therebetween.

Referring to the layout of the reentrant combustion chamber 10 of FIG. 2, a peculiar shape related to the top end 11, slope 14, protrusion 15, bowl rim 16, cone 17, and pip 19 and the relation structure are exemplified.

For example, the top end 11 is formed to have a combustion chamber expansion depth G with respect to the piston top 5a of the piston 5 by cutting the piston top 5a. Accordingly, the combustion chamber expansion depth G of the top end 11 increases the volume of the combustion chamber defined by the inner wall surrounding the pip 19 formed at the center.

For example, the slope 14 starts from a slope start point at the top end 11 and protrudes inward to the protrusion 15 in the combustion chamber and the slope start point defines a slope curve Ra. The protrusion 15 starts from a protrusion start point at the end point of the slope 14 and protrudes inward to the bowl rim 16 in the combustion chamber and the protrusion start point defines a protrusion curve Rb. Accordingly, the slope 14 and the protrusion 15 constitute a profile 13 forming the upper inner wall. In this case, the slope curve Ra is set about 1˜3 R (curve) and the protrusion curve Rb is set about 1˜5 R (curve).

For example, the bowl rim 16 starts from a bowl rim start point at the end point of the protrusion 15 to a bowl rim end position at the end point of the cone 17 and is recessed outward in the combustion chamber, thereby forming a recessed space that forms a bowl rim bottom. In particular, the bowl rim start position defines a bottom curve Re and the bowl rim end position defines a cone curve Rd. Accordingly, the bowl rim curve forming the recessed space of the bowl rim 16 is divided into the bottom curve Rc continuing to the protrusion 15 and the cone curve Rd continuing to the cone 17. Further, the bowl rim 16 is included in the profile 13 forming the lower inner wall and forms the bottom together with the cone 17. In this case, the bottom curve Rc is set about 3˜10 R (curve) and the cone curve Rd is set about 15 R (curve). Accordingly, the bottom of the combustion chamber is formed by the bowl rim bottom is composed of an upper bottom having about 3˜10R (curve) and formed at the protrusion 15 and a lower bottom having about 15R (curve) and formed at the cone 17, thereby having a two-stepped curve composed of two continuous curves. Accordingly, the bottom of the combustion chamber promotes small vortexes through the upper bottom of the bowl rim bottom and the lower bottom of the bowl rim bottom, thereby promoting large vortexes to grow.

For example, the cone 17 starts from a cone start point at the end point of the bowl 16 (end of the lower bottom having about 15R (curve) to the pip 19. In particular, the cone 17 continues straight to the pip 19 and forms a cone angle with respect to the center of the pip 19. In this case, the cone angle A is set about 100˜130°. Accordingly, the cone 17 is formed in the shape of a circular truncated cone with the peak removed to form the flat pip 19 at the top and the oblique side of the truncated cone continuing from the bowl rim 16 to the pip 19 forms a straight section.

For example, the pip 19 is positioned at the center in the combustion chamber and is a cut-surface formed by cutting the tip of the cone 17, thereby forming the cone 17 in a frustoconical shape In particular, the cut-surface of the pip 19 is formed straight, thereby defining a pip diameter d.

A combustion chamber height ratio and a combustion chamber diameter ratio are defined by the parts of the reentrant combustion chamber 10.

For example, the combustion chamber height ratio is set under the condition that the distance between the piston top 5a and the bowl rim bottom of the bowl rim 16 is a combustion chamber height H, the distance between the piston top 5a of the piston 5 and the cut-surface of the cone 17 is a pip depth h, and the distance between the piston top 5a of the piston 5 and the upper end 11 is the combustion chamber expansion depth G In this case, assuming that the combustion chamber height H is 100%, the pip depth h is about 25˜42% and the combustion chamber expansion depth G is about 4˜12%.

According, when the combustion chamber height H is 12˜17 mm, the pip depth h is about 3˜7 mm and the combustion chamber expansion depth G is about 0.5˜2 mm.

For example, the combustion chamber diameter ratio set under the condition that the size that the bowl rim curve center of the bowl rim 16 has with respect to the center in the combustion chamber is a combustion chamber reference diameter D1, the size that the bowl rim curve Rc of the bowl rim 16 has with respect to the center in the combustion chamber is a maximum combustion chamber diameter D3, the size that the protrusion curve Rb of the protrusion 15 has with respect to the center in the combustion chamber is a minimum combustion chamber diameter D2, and the size that the pip 19 has with respect to the center in the combustion chamber is a pip diameter d. In this case, when the combustion chamber reference diameter D1 is 100%, the minimum combustion chamber diameter D2 is about 120˜135%, the maximum combustion chamber diameter D3 is 120˜140%, and the pip diameter d is 10˜15%.

Accordingly, when the combustion chamber reference diameter D1 is Ø30˜50 mm, the minimum combustion chamber diameter D2 is Ø40˜60 mm, the maximum combustion chamber diameter D3 is Ø42˜62 mm, and the pip diameter d is Ø3˜7 mm, Ø means a diameter.

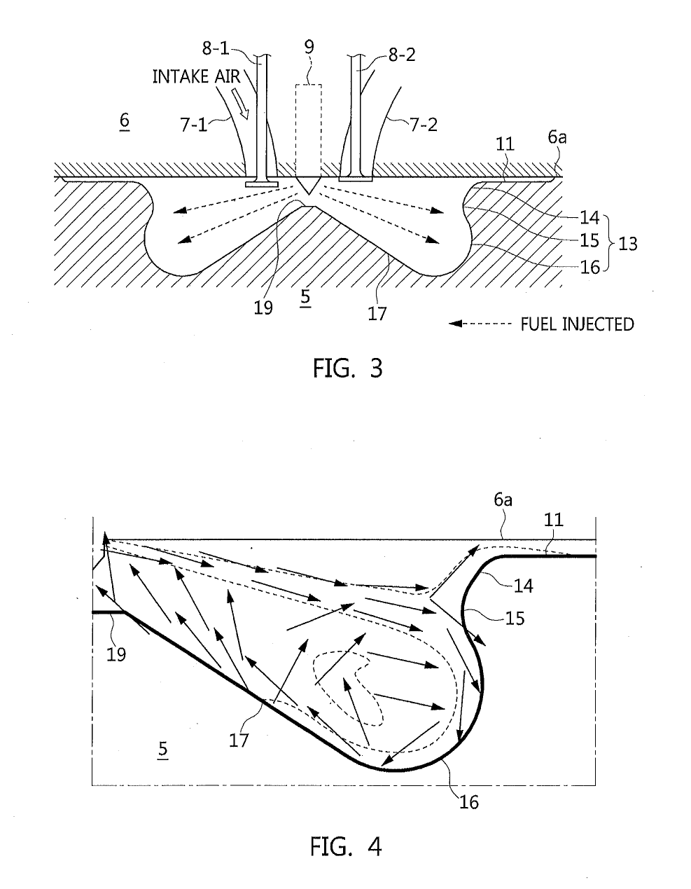

FIGS. 3 to 6 exemplify a large vortex generated in the reentrant combustion chamber 10 and a stream generated toward the center in the combustion chamber when fuel is sprayed, and a 3D combustion analysis.

Referring to FIG. 3, in an intake stroke of the position when the diesel engine 1 is operated, the intake valve 8-1 is opened and air flows into the reentrant combustion chamber 10 through the intake port 7-1, and the injector 9 sprays fuel in a combustion stroke of the piston 5. In this case, the fuel is sprayed in the form of a great number of atomized droplets.

Accordingly, fuel is sprayed to the profile 13, thereby forming streams in which some of the sprayed fuel travels to the slope 14 and most of the sprayed fuel travels to the bowl rim 16 with the protrusion 15 of the profile 13 therebetween. In this case, the slope curve Ra of the slope 14 and the protrusion curve Rb of the protrusion 15 promote the streams of the sprayed fuel.

Referring to the 3D velocity field in the reentrant combustion chamber 10 of FIG. 4, the sprayed fuel and air at the center in the combustion chamber hit against the protrusion 15 and flow down on the protrusion curve Rb to the bowl rim 16, thereby forming a bowl rim stream. The bowl rim stream is promoted by the bottom curve Rc having about 3˜10R (radius) in the space of the bowl rim 16 and this promotion of the bowl rim stream increases kinetic energy of the sprayed fuel.

In particular, the straight section of the cone 17 that continues to the pip 19 smoothly guides the bowl rim stream to the center in the combustion chamber.

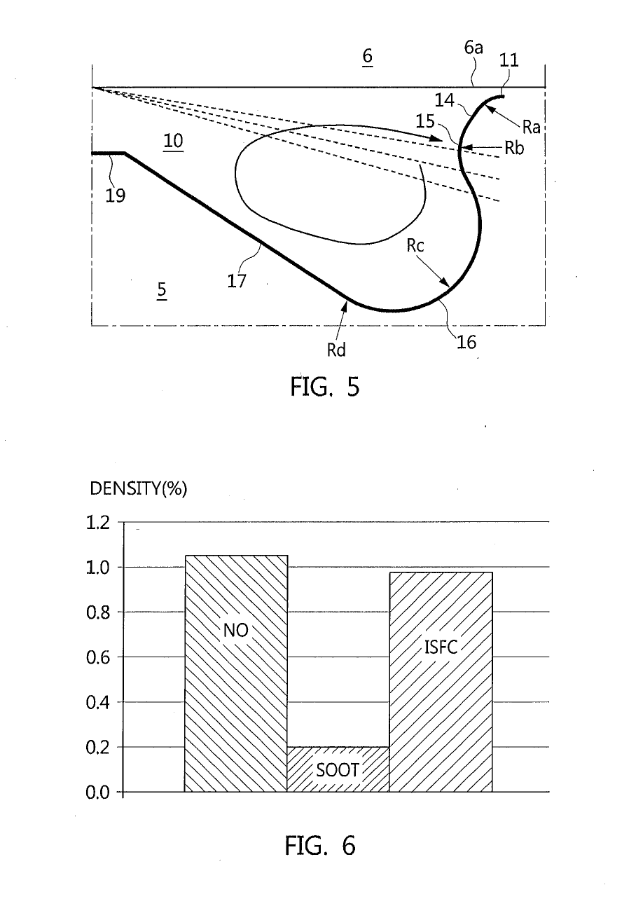

Referring to FIG. 5, in the bowl rim stream, most sprayed fuel, except for some of the sprayed fuel traveling to the pip 19 at the center in the combustion chamber along the straight section of the cone with the kinetic energy increased, forms a vortex that is promoted by the cone curve Rd having about 15R and continuing to the bottom curve Rc. Accordingly, the vortex is promoted to grow into a vortex turning around the bowl rim curve Rc having about 3˜10R, thereby growing the initial vortex into a large vortex.

Referring to FIG. 6 showing an analysis result when, in the reentrant combustion chamber 10, a large vortex is grown by the large curve of the bowl rim 16 and the bowl rim stream is guided to the air at the center by the straight section of the cone 17 so that the entire air in the combustion chamber and refresh air can be burned well.

As shown in the figure, the reentrant combustion chamber 10 greatly reduces NO and soot to ISFC (Indicated Specific Fuel Consumption), thereby remarkably reducing smoke.

As a result, the diesel engine 1 having the reentrant combustion chamber 10 reduces soot, so a the lifespan of a DPF (Diesel Particulate Filter), which is a post-processing device, is increased, whereby fuel efficiency can be improved and, particularly, a swirl control valve that is a device for reducing soot can be removed.

As described above, in the reentrant combustion chamber 10 of the diesel engine 1 of the present embodiment, the profile 13 forms the inlet of the combustion chamber protruding inward in the combustion chamber and the bottom of the combustion chamber through a recessed space that is recessed outward in the combustion chamber. Further, the cone 17 is formed in a truncated cone shape protruding with a straight oblique side at the central space in the combustion chamber and the top end 11 expanding the space of the combustion chamber is formed by extending the top of the profile 13, thereby forming a symmetric structure. Accordingly, a large vortex and a stream of sprayed fuel traveling to the center in the combustion chamber are formed. Therefore, the reentrant combustion chamber 10 is suitable for super-high injection that cannot be achieved from the spray divided type combustion chamber and the 2-step bowl type combustion chamber.

What is claimed is:

1. A reentrant combustion chamber, comprising:
a profile forming the inlet of the combustion chamber that is a projective surface formed inward in the combustion chamber and the bottom of the combustion chamber that is a recessed space that is recessed outward under the inlet in the combustion chamber;
a cone formed in a truncated cone shape continuing from the profile and protruding to the central space in the combustion chamber ; and
a top end for expanding the space of the combustion chamber by expanding the top of the combustion chamber at the inlet of the combustion chamber.

2. The reentrant combustion chamber of claim 1, wherein the profile is divided into a slope, a protrusion, and a bowl rim,
the slope is an inclined surface continuing from the top end to the projective surface, the protrusion that is the projective surface and connects the slope and the bowl rim, thereby forming the inlet of the combustion chamber, and the bowl rim forms the bottom of the combustion chamber that is the recessed space, and
the cone is the truncated cone shape having a straight pip.

3. The reentrant combustion chamber of claim 2, wherein the slope continues to the protrusion through a slope curve formed from the top end.

4. The reentrant combustion chamber of claim 3, wherein the slope curve has a radius of 1˜3 mm.

5. The reentrant combustion chamber of claim 2, wherein the protrusion continues to the bowl rim through a protrusion curve formed from the top end,

6. The reentrant combustion chamber of claim 5, wherein the protrusion curve has a radius of 1˜5 mm.

7. The reentrant combustion chamber of claim 2, wherein the radius center of the recessed space is set as a combustion chamber reference diameter, and when the combustion chamber reference diameter is 100%, the minimum combustion chamber diameter defined by the protrusion is 120˜135%.

8. The reentrant combustion chamber of claim 2, wherein the bowl rim has a bowl curve formed by the recessed space.

9. The reentrant combustion chamber of claim 8, wherein the bowl rim curve is divided into a bottom curve continuing to the protrusion and a cone curve continuing to the cone.

10. The reentrant combustion chamber of claim 9, wherein the bottom curve has a radius of 3˜10 mm and the cone curve has a radius of 15 mm or more.

11. The reentrant combustion chamber of claim 2, wherein the radius center of the recessed space is set as a combustion chamber reference diameter, and when the combustion chamber reference diameter is 100%, the maximum combustion chamber diameter defined by the bowl rim is 120˜140%.

12. The reentrant combustion chamber of claim 2, wherein the radius center of the recessed space is set as a combustion chamber reference diameter, and when the combustion chamber reference diameter is 100%, the pip diameter is 10˜15%.

13. The reentrant combustion chamber of claim 2, wherein the top end is formed by cutting the top of the profile at a combustion chamber expansion depth to expand the combustion chamber, and when the height of the combustion chamber from the bottom to the top of the combustion chamber is 100%, the combustion chamber expansion depth is 4˜12%.

14. The reentrant combustion chamber of claim 2, the pip has a pip depth, and when the height of the combustion chamber from the bottom to the top of the combustion chamber is 100%, the pip depth is 25˜42%.

15. The reentrant combustion chamber of claim 1, wherein the truncated cone of the cone has a cone angle of 100˜130° and a straight oblique side.

16. A diesel engine, comprising a piston having a reentrant combustion chamber defined by: a profile that forms the inlet of the combustion chamber protruding inward in the combustion chamber and the bottom of the combustion chamber through a recessed space that is recessed outward in the combustion chamber; cone that is formed in a truncated cone shape protruding with a straight oblique side at the central space in the combustion chamber; and a top end that expands the space of the combustion chamber and is formed by extending the top of the profile.

17. The diesel engine of claim 16, wherein the reentrant combustion chamber has a left-right symmetric structure with a pip at the center.

18. The diesel engine of claim 16, wherein the inlet of the combustion chamber is formed by connecting a slope curve and a protrusion curve having different sizes.

19. The diesel engine of claim 16, wherein the recessed space is formed by a bowl curve and the bowl curve is formed by connecting a bottom curve and a cone curve that have different sizes.

20. The diesel engine of claim 16, wherein the cone is a truncated cone and forms a tip at the center in the combustion chamber.
